(19) United States
(12) Patent Application Publication
(10) Pub. No.: US 2015/0120409 A1
(43) Pub. Date: Apr. 30, 2015

(54) MARKDOWN OPTIMIZATION SYSTEM HAVING BENEFITS ANALYSIS AND REPORTING

(71) Applicant: International Business Machines Corporation, Armonk, NY (US)

(72) Inventors: Saibal Bhattacharya, San Mateo, CA (US); Charles Tze-Chao Ng, Union City, CA (US); Siqun Wang, San Carlos, CA (US); Monica S. Wong, San Francisco, CA (US)

(73) Assignee: International Business Machines Corporation, Armonk, NY (US)

(21) Appl. No.: 14/062,812

(22) Filed: Oct. 24, 2013

(51) Int. Cl. G06Q 30/02

(52) U.S. Cl. CPC G06Q 30/0211
USPC 705/14.13

(57) ABSTRACT

Techniques are described for generating benefits reports for a markdown optimization system. As described herein, a markdown optimization system executes markdown optimization software that applies to compute markdown schedules for retailers. In addition, the markdown optimization system applies techniques to reliably approximate and quantify the benefit derived by a given retailer from using of a computed markdown schedule instead of utilizing a user-defined schedule.

### TECHNICAL FIELD

The disclosure relates to retail markdown optimization systems.

### BACKGROUND

Retailers are often faced with the situation of having excess or older inventory that needs to be cleared from the shelves. In such cases, retailers often follow price reduction schedule in order to achieve at least some profit while the remaining inventory is sold to customers.

In order to increase profit, many retailers have adopted software, referred to herein as markdown optimization (MDO) software, that automatically computes recommended markdown schedules for inventory needed to be cleared. That is, for a given inventory currently maintained by a retailer, the MDO software applies certain algorithms to determine a markdown schedule according to which the retailer is to reduce the retail price of the product, thereby clearing the inventory while maximizing revenue. For example, the MDO software may generate the markdown schedule so as to specify optimal markdown percentages by which the price of the inventory is to be periodically reduced (e.g., weekly) basis over the duration of the schedule. Moreover, the MDO may utilize actual sales data, including actual volumes and actual price, and may compare this data to the initial inventory for a given week so as to alter the markdown percentage based on the perceived demand and the actual supply.

One primary advantage of utilizing MDO software is that the software provides real-time feedback that allows a retail store to alter its pricing schemes to realize increased profits. Though this may be beneficial, such benefits are often difficult to quantify. That is, it may be difficult for a business leader associated with the retailer to determine how much additional profit the retailer realized by using the MDO software rather than following a static, user-defined schedule.

### SUMMARY

Techniques are described for generating benefits reports for a markdown optimization system. As described herein, a markdown optimization system executes markdown optimization software that applies to compute markdown schedules for retailers. In addition, the markdown optimization system applies techniques to reliably approximate and quantify the benefit derived by a given retailer from using a computed markdown schedule instead of utilizing a user-defined schedule.

In one example, a method comprises accessing, with a computer, a recommended markdown schedule, wherein the recommended markdown schedule was generated in accordance with an econometric model and specifies pricing reductions for a set of products over a period of time. The method further comprises updating the econometric model based on data indicative of actual unit sales of the products that occurred when the products were sold in accordance with the recommended markdown schedule, and computing, based on the updated econometric model, a profit difference between the sale of the products in accordance with the recommended markdown schedule and sale of the products in accordance with a user-defined markdown schedule. The method may further include outputting a profit benefit report indicative of the computed profit difference.

In another example, a markdown optimization system comprises one or more processors, and an optimization engine executed by the one or more processors to compute, in accordance with an econometric model, a recommended markdown schedule that specifies pricing reductions for a set of products over a period of time. The markdown optimization system further comprises a recalibration module that updates the econometric model based on data indicative of actual unit sales of the products that occurred when the products were sold in accordance with the recommended markdown schedule. In addition, the markdown optimization system includes a report generation module that computes, based on the updated econometric model, a profit difference between the sale of the products in accordance with the recommended markdown schedule and sale of the products in accordance with a user-defined markdown schedule.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system for requesting a benefits report from a markdown optimization (MDO) system.

FIG. 2 is a block diagram illustrating further details of an example implementation of the MDO system illustrated in FIG. 1.

FIG. 3A through 3F illustrate example graphical user interfaces presented by the MDO system.

FIG. 4 is a flow diagram illustrating example operation of the MDO system when generating a benefits report.

FIG. 5 is a flow diagram illustrating, in greater detail, a recalibration process of performed by the MDO system when generating a benefits report.

FIG. 6 is a block diagram of an example computing device that may run a markdown optimization application with benefits report generation.

### DETAILED DESCRIPTION

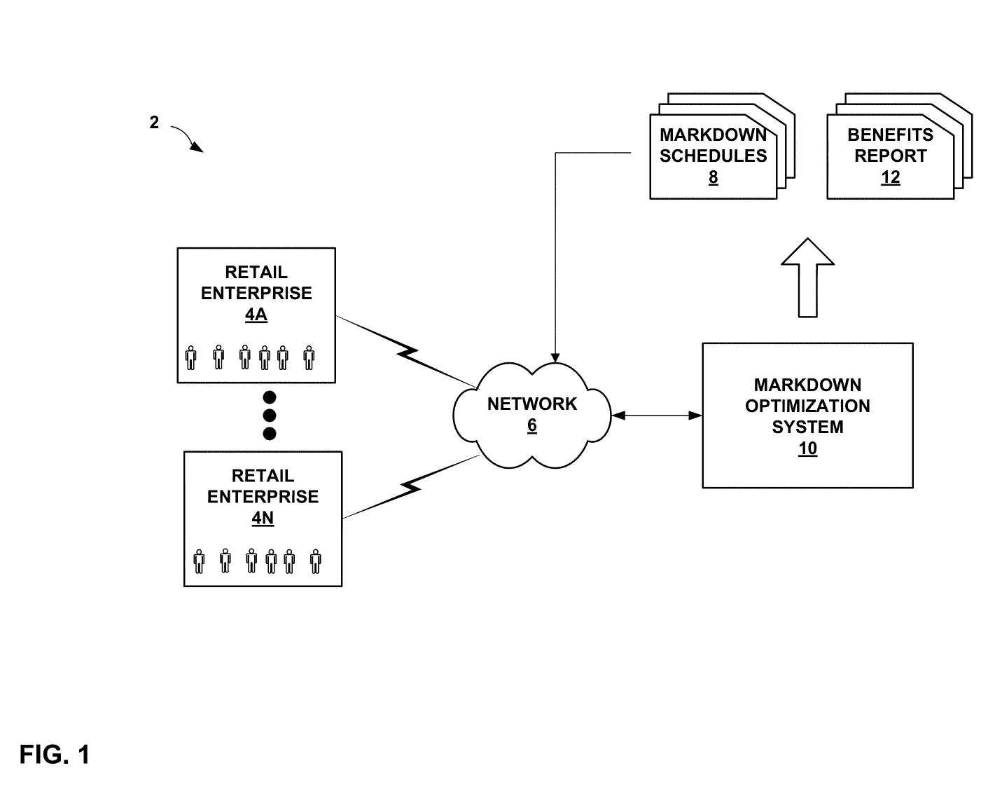

FIG. 1 is a block diagram illustrating an example system 2 in which a markdown optimization (MDO) system 10 provides a network-based solution for generating markdown schedules 8 and corresponding benefits reports 12. In the example of FIG. 1, system 2 includes a plurality of retail enterprises 4A through 4N (collectively, retail enterprises 4), coupled to MDO system 10 by network 6. In general, MDO system 10 computes markdown schedules 10 for retail enterprises 4. Moreover, as described in further detail below, MDO system 10 computes benefits report 12, each of which provides a reliable quantification of the benefit derived by a given one of retailers 4 from using of corresponding computed markdown schedule 8 instead of utilizing its own user-defined markdown schedule.

In the example of FIG. 1, retail enterprises 4 access and utilize MDO system 10 via network 6. Retail enterprises 4 may be, for example, any entity that transfers goods, including a wholesale outlet, a big box store, a novelty store, a brand specific store, an Internet sales company, a food distributor, or a specialty store, or other enterprise that sells goods.

MDO system 10 is illustrated in FIG. 1 as a cloud-based service that provides retail enterprises 4 with markdown services, including computation of markdown schedules 10 specifying optimized pricing for inventory maintained by retail enterprises 4. In one example implementation, MDO system 10 generates markdown schedules 10 to provide relative optimized pricing for markdown items and provides pricing and a promotion calendar for non-markdown items. Although shown as a hosted, cloud-based service, MDO system 10 may be implemented as program code executed locally by computing devices of retail enterprises 4. Further details of one example implementation of MDO system 10 may be found in U.S. patent application Ser. No. 11/534,986, “PRICE MARKDOWN APPARATUS,” filed Sep. 25, 2006, the entire contents of which are incorporated herein by reference.

In this example, retail enterprises 4 access markdown optimization system 10 via network 6. Network 6 may represent any communication network, such as a packet-based digital network. In other examples, network 6 may represent any wired or wireless network such as the Internet, a private corporate intranet, or a PSTN telephonic network. Network 6 may include both wired and wireless networks as well as both public and private networks. Retail enterprises 4 and MDO system 10 may each contain one or more devices for accessing network 6, such as modems, switches and the like. For example, each of retail enterprises 4 may comprises one or more computers coupled to a respective private local area network. Network access devices (e.g., a router and firewall) may couple the private network to network 6 for communication with computing devices associated with markdown optimization system 10.

In general, individual retailers 4 access markdown optimization system 10 and provide raw data defining a specified econometric scenario, e.g., a particular set of goods to be cleared, sales, cost and competitive data. In response, an econometric modeling engine within markdown optimization system 10 constructs a model for each econometric scenario, where the model represents the various factors affecting behaviors represented by the data. In one example, the econometric engine computes coefficients for the model to represent the driving factors for consumer demand, synthesized from sales volume and other retail-business related data inputs provided by retailers 4. Upon construction of the model, an optimization engine process the computed model to generate a corresponding markdown schedule 8 that specifies a set of markdown prices that are computed to realize user goal (profit, sales etc.) while obeying various business constraints (observing inventory levels, observing cadence of prices suggested by the user etc).

As described herein, markdown optimization system 10 applies techniques to reliably approximate and quantify the benefit derived by a given retailer 4 upon using of a computed markdown schedule 8 instead of utilizing a user-defined schedule. More specifically, after execution of a given markdown schedule 8, a retail enterprise 4 associated with the schedule may direct markdown optimization system 10 to access a markdown schedule and generate a benefit analysis for the markdown schedule. In response, markdown optimization system 10 recalibrates the specific econometric model associated with the markdown schedule based on actual unit sales achieved during execution of the markdown schedule. That is, markdown optimization system 10 recalibrates the model, e.g., by scaling coefficients within the model based on data describing the actual unit sales achieved (“actuals”) for each store by product and week. Markdown optimization system 10 applies the updated model to a user-defined pricing structure to compute a forecast of sales that the given retail enterprise would have realized but for the markdown schedule computed by MDO system 10. Markdown optimization system 10 compares this forecast with the actual unit sales achieved to compute and illustrate a benefit achieved by retail enterprise 4 relative to any user-defined strategy that the retailer would have otherwise used. Markdown optimization system 10 generates this information in the form of benefits reports 12.

Benefits report 12 could take a number of forms. For example, markdown optimization system 10 may present markdown benefits reports 12 to users by a web-based interface, such as by a renderable HTML page. As other examples, benefits report 12 may take the form of a file which is transferred (e.g., by email or FTP) to a user upon generation. Benefits report 12 could also be displayed in an interface at retail enterprises 4. Benefits report 12 could further be exported to a spreadsheet program for further aggregation and analysis by retail enterprises 4. Benefits report 12 could contain a variety of information, including the actual unit sales data from the use of the markdown schedule, a prediction of what would have happened without the use of MDO system 10 based on the user-defined schedule, and the difference from what actually happened through the use of the MDO system and what would have happened without the use MDO system 10 based on the user entries, among other things.

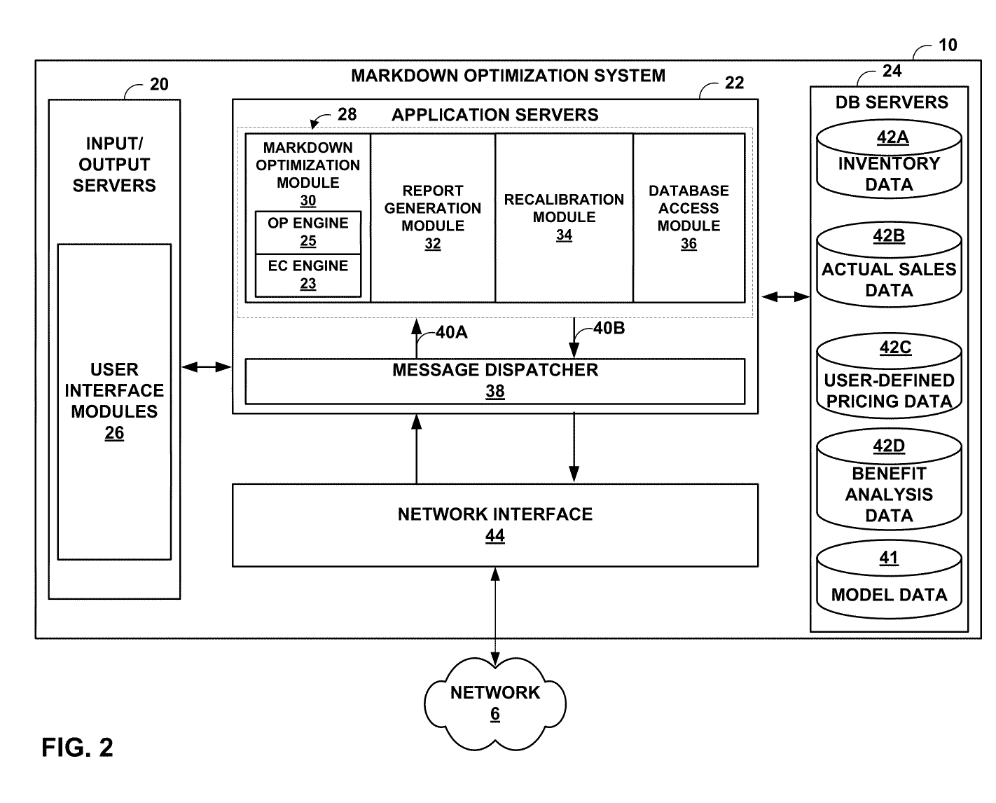

FIG. 2 is a block diagram illustrating further details of an example implementation of MDO system 10 illustrated in FIG. 1, in accordance with one or more aspects of the present disclosure. As described, MDO system 10 generates markdown optimization schedules 8 and, for any given schedule, may receive requests for generating benefits reports estimating the actual benefit derived by use of the markdown schedule.

In this example, MDO system 10 includes one or more computing devices (e.g., computing servers that provide operating environments for various software modules). These servers can generally be categorized as input/output (IO) servers 20, application servers 22, and database servers 24. Although these servers are illustrated separately in FIG. 2, MDO system 10 may, in various examples, be realized by a single computing device or a plurality of cooperating computing devices, as the case may be.

10 servers 20 provide an interface by which one or more users (e.g., any of retail enterprises 4) may communicate with MDO system 10. In some examples, IO servers 20 may be web servers that execute web server software. As such, IO servers 20 may provide an environment for interacting with remote data and applications according to user interface modules 26, which can include Active Server Pages, web pages written in hypertext markup language (HTML) or dynamic HTML, Active X modules, Lotus scripts, Java scripts, Java Applets, Distributed Component Object Modules (DCOM) and the like. In other examples, IO servers 20 may be servers capable of establishing a connection to employees via a corporate intranet, or public network (e.g., via a virtual private network connection) and transferring information. Although illustrated as “server side” software modules executing within an operating environment provided by IO servers 20, user interface modules 26 could readily be implemented as “client side” software modules executing on computing devices used by one or more remote users, such as those of employees of retail enterprises 4.

Network interface 44 provides various interfaces and/or modules that provide the ability to establish connections with one or more remote devices, such as devices located in retail enterprises 4. As shown in FIG. 2, network interface 44 may enable MDO system 10 to communicate over network 6. In this manner, MDO system 10 can interact with retail enterprises 4.

Application servers 22 provide an operating environment for application software modules 28, which provide the underlying logic and functionality for implementing the various techniques ascribed to MDO system 10 herein. Message dispatcher 38 receives communications from other components associated with MDO system 10, such as network interface 44 or IO servers 20, and issues inbound messages 40A to applications software modules 28 to process the communications. In particular, network interface 44 may receive communications from remote devices (e.g., retail enterprises 4 or requests from IO servers 20), and, in turn, forward the communications to message dispatcher 38. Message dispatcher 38 determines the appropriate application software modules 28 for processing each communication, and dispatches one or more inbound messages 40A to the identified modules. In a similar manner, application software modules 28 may generate outbound messages 40B to communicate with remote devices or users via network 6 or IO servers 20.

In the example of FIG. 2, application software modules 28 execute on an operating environment provided by application servers 22 and interact with database servers 24 to access a number of data stores 42, including inventory data 42A, actual sales data 42B, user-defined pricing data 42C, and benefit analysis 42D. Data stores 42 may be implemented in a number of different forms including data storage files, or as a database management system (DBMS). The database management system may be a relational (RDBMS), hierarchical (HDBMS), multidimensional (MDBMS), object oriented (ODBMS or OODBMS) or object relational (ORDBMS), or other database management system. Furthermore, although illustrated separately, data stores 42 could be combined into a single database or other data storage structure. Data stores 42 could, for example, be implemented as a single relational database (such as that marketed by Microsoft® Corporation under the trade designation ‘SQL SERVER”).

Data stores 42 each store data associated with the markdown optimization services provided to retail enterprises 4. For example, model data 41 contains raw data provided by retailers 4 so as to define an econometric scenario and also provides a repository for storing the models constructed by markdown optimization system 10 when providing the markdown optimization services. In addition, inventory data 42A may data describing inventory, i.e., products, that are currently or previously the subject of markdown optimization. Moreover, inventory data 42 may specify weekly inventory levels for relevant inventory maintained by retail enterprises 4. Actual sales data store 42B may contain information regarding the actual unit sales achieved during execution of one or more markdown optimization schedules. User-defined pricing data 42C may contain information regarding user-defined pricing schemes for retail enterprises 4. Benefit analysis 42D may contain information derived from generating benefits reports 8 based on information contained in inventory data 42A, actual sales data 42B, and user-defined pricing data 42C for retail enterprises 4A. In other words, for various ones of retail enterprises 4, each of inventory data 42A, actual sales data 42B, user-defined pricing data 42C, and benefit analysis 42D may store current information relating to the retail enterprise, as well as previous information.

Database access module 36 handles and/or processes receipt, storage, and retrieval of data received from various sources, such as from IO servers 20 or network interface 44. For instance, database access module 36 may receive, as part of inbound messages 40A, an identification of a user-defined pricing scheme by a particular one of retail enterprises 4. In turn, database access module 36 may access database servers 24 and create a record within user-defined pricing data 42C to log the received user-defined pricing scheme. The record may, for example, specify: (1) a starting price for a product, (2) a length of time for the markdown schedule, and (3) a series of markdown percentages for the product. In one example, database access module 36 may receive, as part of inbound messages 40A, a markdown optimization schedule from a user, such as retail enterprise 4A. Database access module 36 may access database servers 24 and create or modify records within inventory data 42A and actual sales data 42B to record the changing inventory levels and the optimal pricing scheme, respectively.

Inventory data 42A could contain other information, such as the starting price for a product, weekly inventory levels, retail store identifier, product identifier, and weekly volumes of product sold, among other things. Actual sales data 42B could contain other information, including retail store identifier, product identifier, length of time for the markdown schedule, previous markdown rates, and current markdown rates, among other things.

As shown in FIG. 2, application software modules 28 may include a number of modules including markdown optimization (MDO) module 30, report generation module 32, recalibration module 34, and database access module 36. MDO module 30 handles and/or processes requests to generate a MDO schedule for a user, such as any of the retail enterprises 4. In this example, MDO module 30 includes an econometrics engine 23 to construct a model within model data 41 to represent the econometric scenario defined by the user. Optimization engine 25 processes model data 41 to generate markdown schedules 12. During this process, MDO module 30 may communicate with database access module 36 to access database servers 24. For instance, MDO module 30 may receive instructions, as part of inbound messages 40A, to create a MDO schedule for one of the retail enterprises 4. The instructions may be received by application servers 22 from IO servers 20, or from network interface 44. MDO module 30 may communicate with database access module 36 to retrieve relevant data from data stores 42.

Report generation module 32 handles and/or processes requests to generate a benefits report 12 for a user, such as any of the retail enterprises 4. Report generation module 32 may communicate with database access module 36 to access database servers 24. Report generation module 32 may also communicate with recalibration module 34 to obtain a recalibration factor for use in generating the benefits report. For instance, report generation module 32 may receive instructions, as part of inbound messages 40A, to create a benefits report for one of the retail enterprises 4. The instructions may be received by application servers 22 from IO servers 20, or from network interface 44.

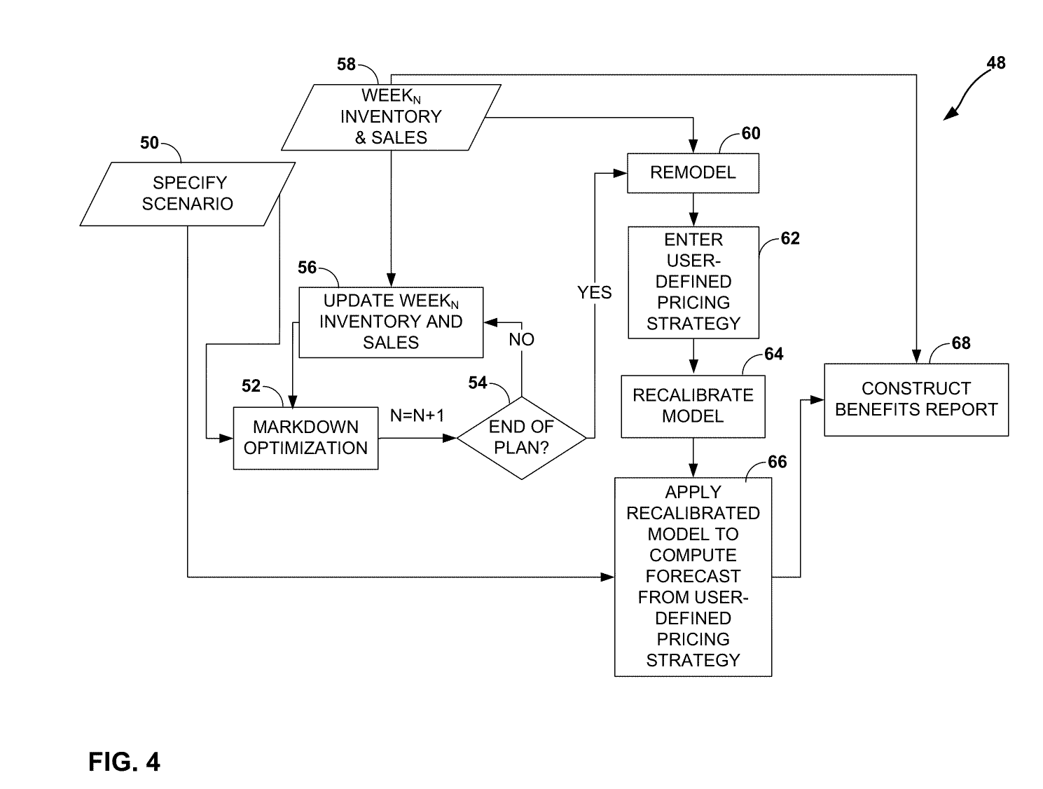

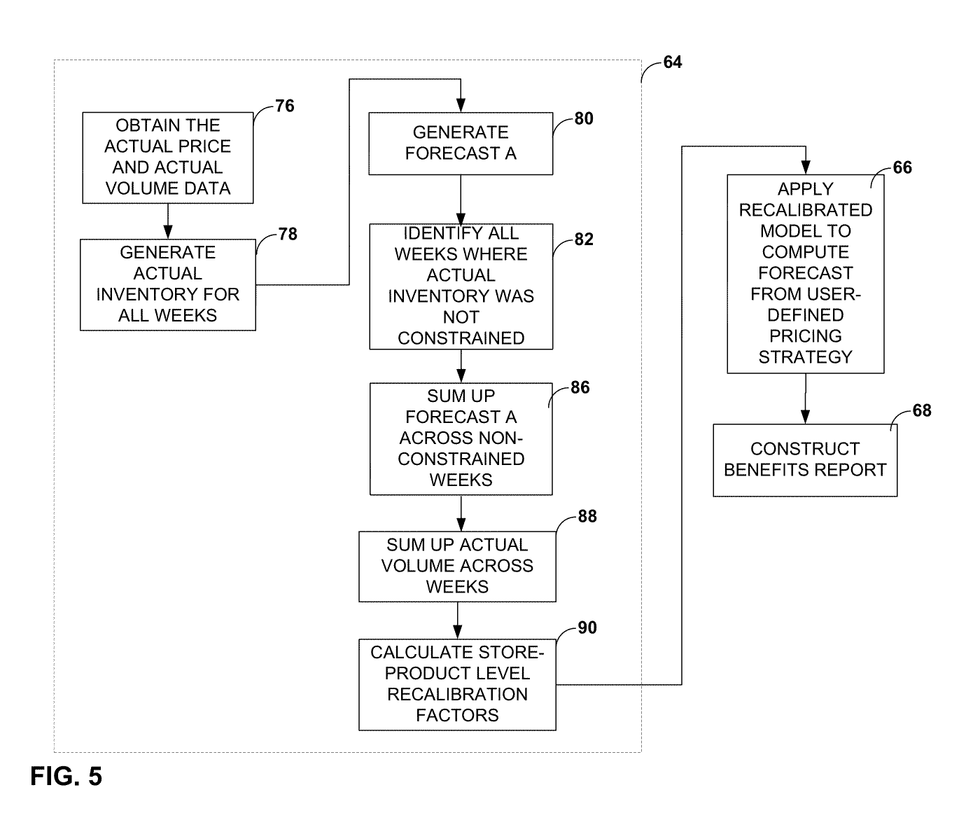

Report generation module 32 may communicate with database access module 36 to retrieve relevant data from data stores 42. In some examples, report generation module 32 may access inventory data 42A, actual sales data 42B, and user-defined pricing data 42C in order to generate a benefits report. For instance, report generation module 32 may access the weekly inventory levels, weekly volumes of product sold, and the starting price for a specific product at a specific store from the inventory data 42A. The report generation module 32 may then access the length of time for the markdown schedule and previous markdown rates from actual sales data 42B. The report generation module 32 may then access the user-defined price scheme stored in the user-defined pricing data 42C. In some examples, the report generation module 32 may also communicate with recalibration module 34 to determine a recalibration factor. Using techniques discussed in FIG. 4 and FIG. 5, a benefits report may be generated. This benefits report could be stored in benefit analysis data store 42D. The benefits report could also be sent via outbound messages 40B to the message dispatcher 38, where it is forwarded to one of the retail enterprises 4 via the network 6 and network interface 44.

Recalibration module 34 handles recalibration of existing models within model data 41 when computing an actual benefit received from execution of a markdown schedule associated with the particular model. These requests would be communicated from report generation module 32. Recalibration module 34 may then communicate with database access module 36 to retrieve the needed information from database servers 24 and data stores 42. In one example, the recalibration module 34 may access the weekly inventory levels, weekly volumes of product sold, and the starting price for a specific product at a specific store from the inventory data 42A. The recalibration module 34 may then access the length of time for the markdown schedule and previous markdown rates from actual sales data 42B. The recalibration module 34 may then access the user-defined price scheme stored in the user-defined pricing data 42C. Using techniques discussed in FIG. 5, a recalibration factor may be generated. This recalibration factor may then be sent to report generation module 32.

Message dispatcher 38 may communicate the generated report to other components of MDO system 10, such as network interface 44 or IO servers 20. In one example, application servers 22 may communicate with IO servers 20 to relay the report, and IO servers 20 may output the report via user interface modules 26 to one or more users, such as retail enterprises 4. A user may then review the report, and adjust future use of their particular optimization software accordingly.

In this way, MDO system 10 generates markdown optimization schedules 8 and, for any given schedule, generates benefits reports 12 estimating the actual benefit derived by retailer 4 after executing the markdown schedules.

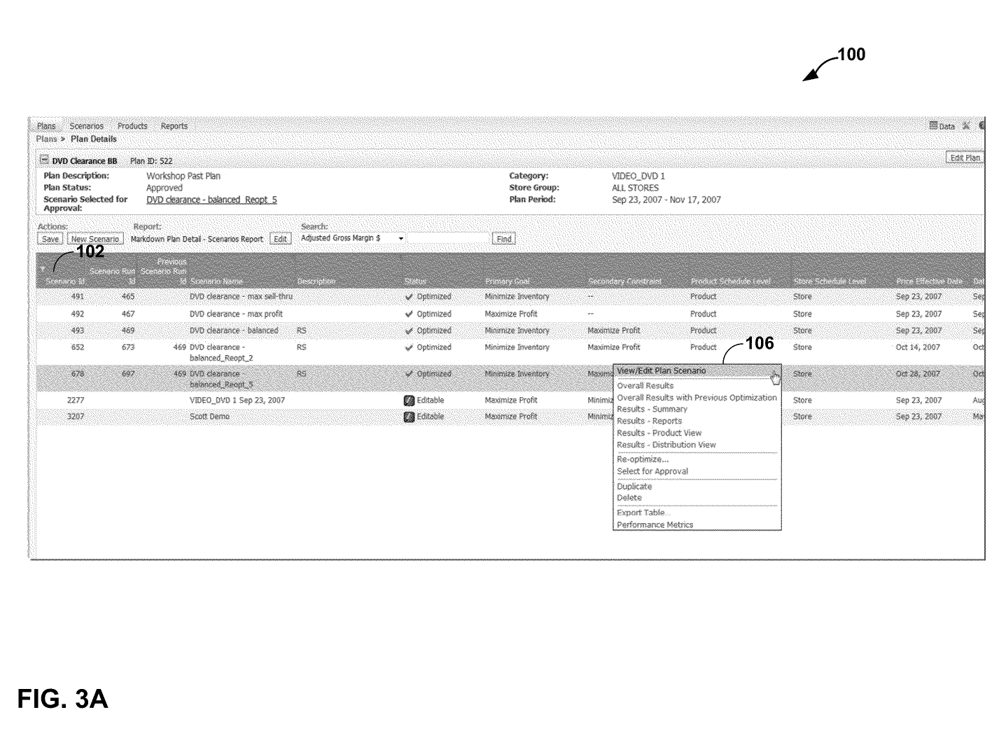

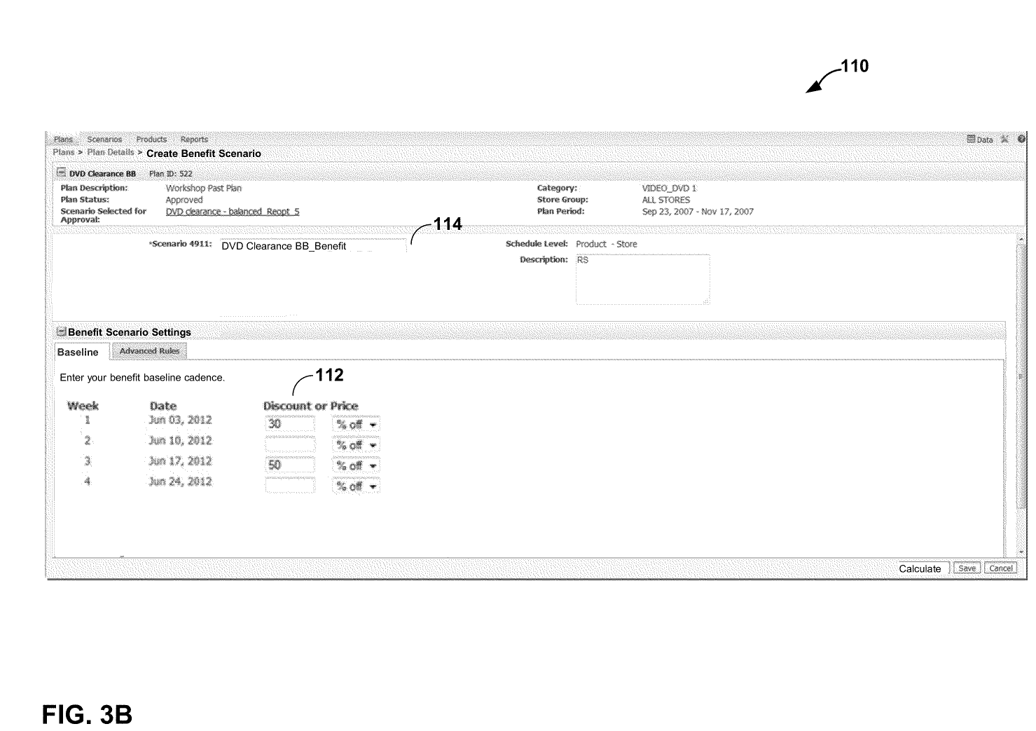

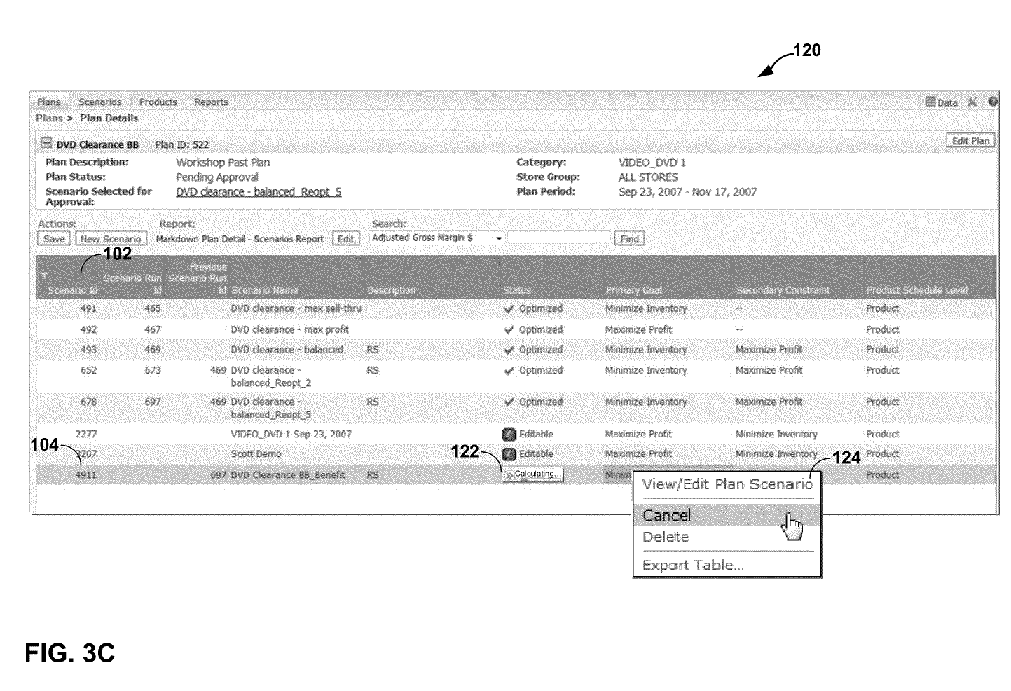

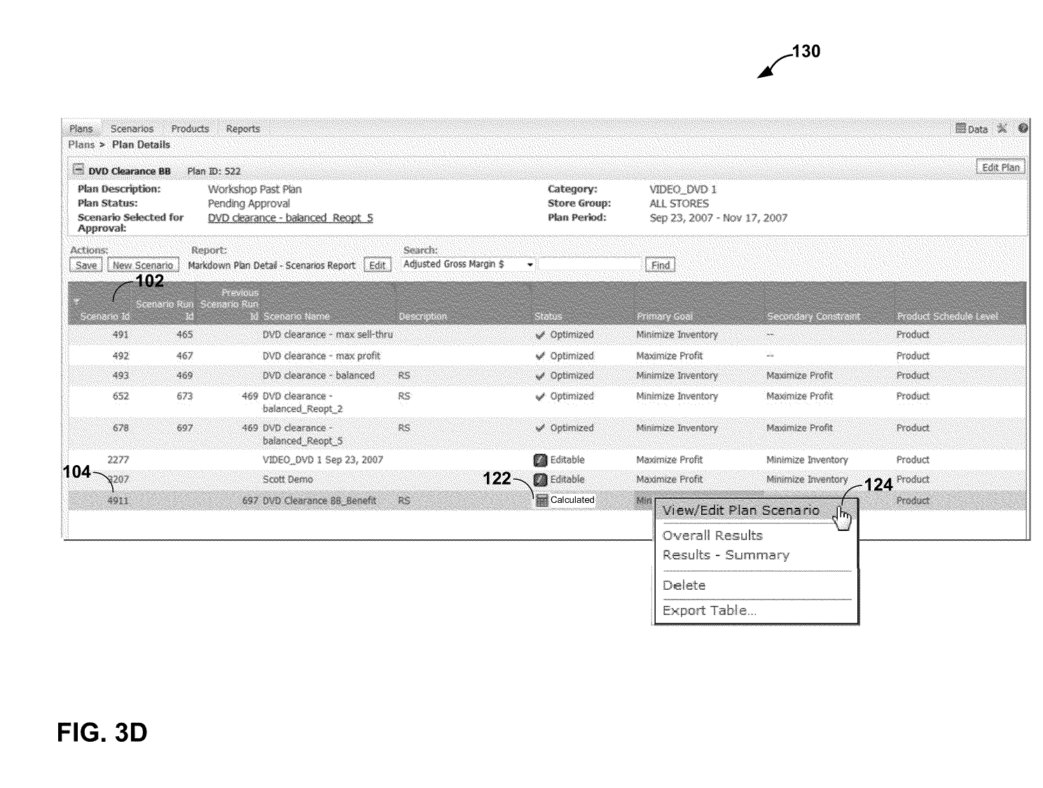

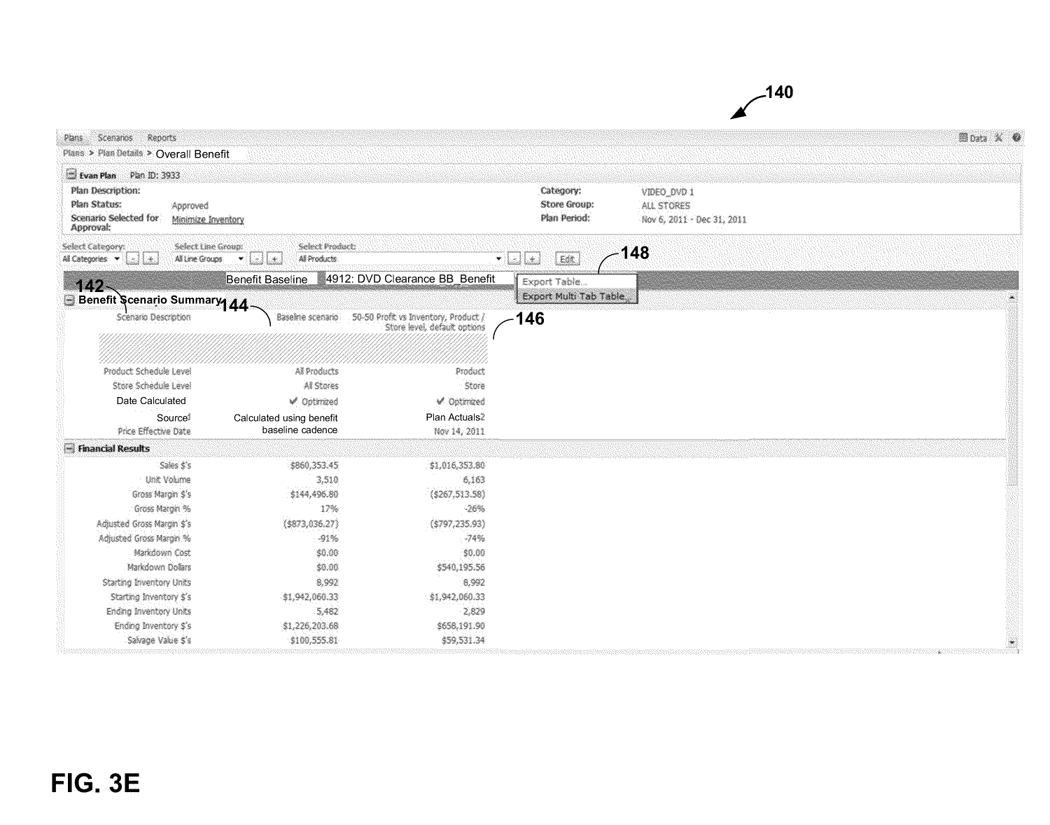

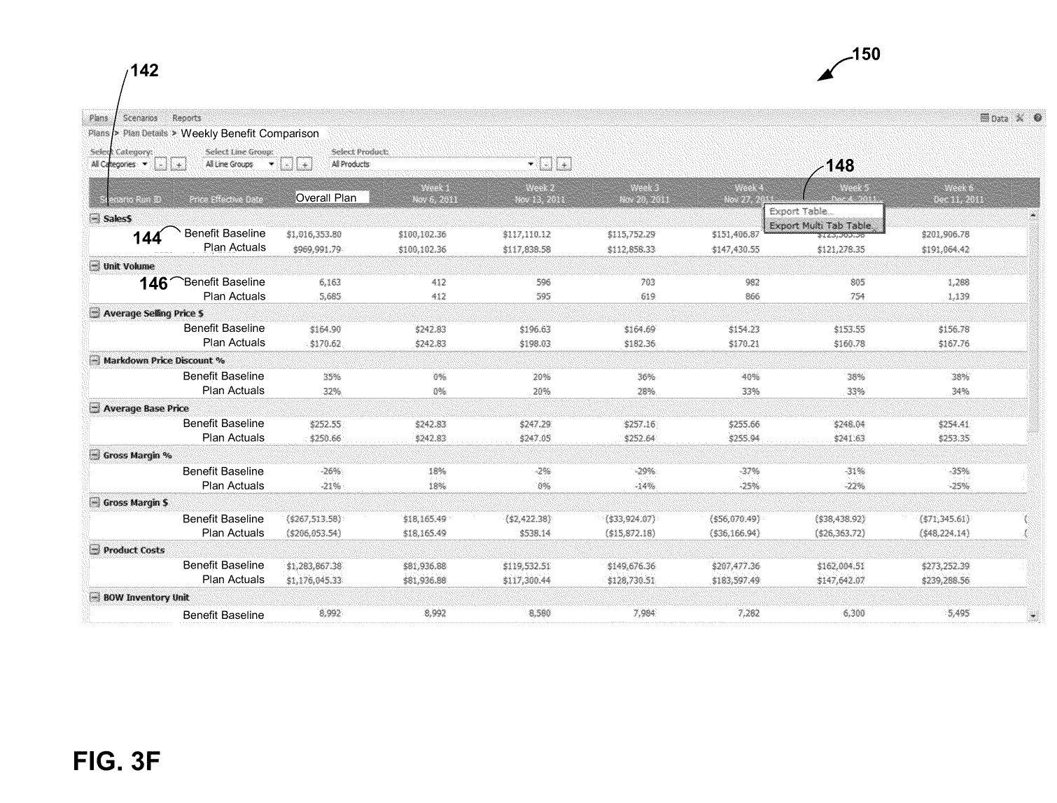

FIG. 3A through 3F illustrate example graphical user interfaces (GUIs) presented by user interface module 26 of FIG. 2. FIG. 3A illustrates an example user interface 100 showing a list of scenarios 102 defined by users associated with retail enterprises 4. The list of scenarios 102 can show one or many different econometric scenarios including a user-defined pricing scheme for comparison to an optimal pricing schedule computed by MDO system 10 for the purposes of generating a benefits report. Each econometric scenarios 102 could have a variety of other properties associated with it, including scenario ID, scenario name, description, status, primary goal, secondary constraint, product schedule level, store schedule level, and price effective date, among other things.

In response to selection of a given scenario 104, user interface 100 presents a menu of possible actions 106 associated with the scenario. For instance, in this menu of possible actions 106, the user can view the plan scenario, edit the plan scenario, see the overall results, the overall results with previous optimization, a results summary, a results report, a results product view, and a results distribution view, re-optimize the scenario, select the scenario for approval, duplicate the scenario, delete the scenario, export the scenario, or see the performance metrics, among other things.

FIG. 3B shows an example user interface 110 showing a list of pricing scheme inputs 112, as it may be displayed on a screen of user interface modules 26 for a MDO system 10. Example user interface 110 includes pricing scheme inputs 112 by which a user can enter a pricing scenario that the retailer would have implemented if the retailer did not use MDO system 10. In each of the pricing scheme inputs 112, the user can select a percentage discount or a static cost discount for each week of the user-defined pricing scheme. The user can also edit the name 114 of the user-defined pricing scheme in this user interface.

FIG. 3C shows an example user interface 120 upon the user directing MDO system to generate a benefits report. As shown in FIG. 3C, user interface 120 provides a status indicator 122 indicating that markdown system 10 is calculating the benefits report 12 for scenario 104. While the status 122 is shown as calculating, the user can generate menu 124 to perform an action with regards to user-defined pricing scheme 104. For instance, the user can view the plan scenario, edit the plan scenario, cancel the report generation, delete the scenario, or export the table, among other things.

FIG. 3D shows an example user interface 130 in which status identifier 122 has been updated to indicated that the benefits report for scenario 103 has been fully calculated and may be viewed by the user. That is status indicator 122 is shown as “calculated,” meaning the user has generated a benefits report using user-defined pricing scheme 104 and all calculations needed to generate the benefits report have completed. While the status 122 is shown as calculated, the user can generate menu 124 to perform an action with regards to user-defined pricing scheme 104. For instance, the user can view the plan scenario, edit the plan scenario, see the benefits report, see a summary of the results, delete the scenario, or export the table, among other things.

FIG. 3E shows an example benefits report page 140 showing a list of statistics 142 used in the benefits report, as it may be displayed on a screen of user interface modules 26 for a MDO system 10. Statistics column 142 shows various statistics used to compare the user-defined pricing scheme 144 and the optimal pricing scheme 146. The statistics column 142 could include product schedule level, store schedule level, date calculated, source, price effective date, sales in dollars, unit volume, gross margin in dollars, gross margin in percentage, adjusted gross margin in dollars, adjusted gross margin in percentage, markdown cost, markdown dollars, starting inventory units, starting inventory in dollars, ending inventory units, ending inventory in dollars, and salvage value in dollars, among other things.

User-defined pricing scheme 144 and the optimal pricing scheme 146 can be displayed on the same page so as to easily see the benefits from using the optimal pricing scheme as compared to the user-defined pricing scheme. The user can also generate menu 148 to perform certain actions on the benefits report page 140, such as exporting the table or exporting the table as a multi-tab table, among other things.

FIG. 3F shows a second example benefits report page 150 showing a list of statistics 142 used in the benefits report, as it may be displayed on a screen of user interface modules 26 for a MDO system 10. Statistics column 142 shows various statistics used to compare the user-defined pricing scheme 144 and the optimal pricing scheme 146. This benefits report page 150 further breaks down the benefits report to show the user a weekly count of the various statistics 142. The statistics column 142 could include product schedule level, store schedule level, date calculated, source, price effective date, sales in dollars, unit volume, gross margin in dollars, gross margin in percentage, adjusted gross margin in dollars, adjusted gross margin in percentage, markdown cost, markdown dollars, starting inventory units, starting inventory in dollars, ending inventory units, ending inventory in dollars, and salvage value in dollars, among other things.

User-defined pricing scheme 144 and the optimal pricing scheme 146 can be displayed on the same page so as to easily see the benefits from using the optimal pricing scheme as compared to the user-defined pricing scheme. The user can also generate menu 148 to perform certain actions on the benefits report page 140, such as exporting the table or exporting the table as a multi-tab table, among other things.

FIG. 4 is a flow diagram illustrating example operation of MDO system 10 when generating a benefits report 12. In example, a user associated with a retail enterprise access MDO system 10 and inputs raw data to define an econometric scenario including entering data specifying the initial inventory, referred to as Week₀ inventory (50). At this time, the user may specify the particular set of goods to be cleared, previous sales and cost associated with the goods, competitive data and other constraints.

Next, MDO system 10 performs markdown optimization to generate a markdown optimization schedule that is implemented by the retail enterprise (52). At this time, econometric modeling engine 23 within markdown optimization system 10 constructs within model data 41 a model for the econometric scenario and computes coefficients for the model to represent the driving factors for consumer demand, synthesized from sales volume and other retail-business related data inputs provided by the user. Upon construction of the model, optimization engine 25 process the computed model to generate a corresponding markdown schedule 8 that specifies a set of markdown prices that are computed to realize a user-defined goal (e.g., maximize profit) while obeying various business constraints (observing inventory levels).

Once MDO system 10 has computed the markdown schedule, the retail enterprise implements the plan according to the defined pricing schedule (54, 56). During this process, the retail enterprise periodically (e.g., weekly) updates MDO system 10 with sales data and current inventory levels (Week_{N} inventory) (56). These new inventory and sales figures are fed into a MDO application 52, and the process recurs until the retail enterprise 4 determines that the plan has ended (54). When the plan has ended, all data, including the inventory data, the sales data, and the markdown percentages are saved to the database servers 24, the inventory data 42A, and the actual sales data 42B.

At this time, or even during execution of the plan, the user may direct MDO system to produce a benefit report to provide a detailed estimate of the benefit received to date by the retail enterprise from implementation of the markdown schedule. In response, report generation module 32 rebuilds the model by first updating the scenario data to reload actual point of sale data, including the actual prices and volumes of products sold over the period (60). At this time, econometric engine 23 may modify the model based on the actual data to more accurately reflect an estimate of the actual elasticity observed over the markdown period. In this way, econometric engine 23 begins the process of adjusting the model used for markdown optimization to accurately reflect the actuals achieved by the retail enterprise. Although shown for purposes of example in FIG. 4 as occurring after the completion of the markdown schedule, econometric engine 23 may update the econometric model during, i.e., in parallel with, execution of the markdown schedule. Moreover, although shown by way of example with respect to a markdown schedule computed my MDO system 10, the original markdown schedule may have been computed by a different system. In any case, MDO system 10 accesses and remodels the original markdown schedule based on the actuals.

In addition, MDO system 10 presents a user interface (e.g., user interface 110) by which user then enters a baseline strategy, referred to herein as a user-defined strategy (62). This baseline strategy specifies a user-defined pricing scheme, which is a scheme that the retail enterprise 4 would have used had they not used a MDO application. This baseline strategy could be entered in a variety of ways, including entering the prices for each product-store-week, or each week that the product is subjected to the MDO scheme, for the entire markdown period.

Next, recalibration module 34 manipulates the updated model within model data 41 for the scenario to calibrate the model based on the actuals received from the user (64). In general, recalibration module 34 re-computes the coefficients of the model so as to scale the model to accurately reflect actual change in demand as a function of price observed by the retail enterprise when implementing the markdown schedule. This technique is further discussed in FIG. 5.

Once the recalibration has occurred such the updated model has been scaled to reflect actual demand experienced during the markdown period, the recalibration module 34 applies the user-defined pricing scheme to the model to compute a forecast for sales in view of the prices that the user would have selected but for using MDO system 10 (66). This process produces a recalibrated forecast for the user-defined pricing strategy, giving a predicted set of point of sale data for each product-store-week for the pricing strategy that would have been applied by the user but for MDO system 10.

This allows for meaningful comparisons between the user-pricing strategy and the actuals achieved by the pricing scheme of the markdown schedule computed by MDO system 10. That is, report generation module 32 generates benefits report 12 by calculating and illustrating the differences between application of the recalibrated model to the user-defined pricing strategy and the actual data achieved for both sales and inventory level when the retail enterprise implemented the pricing scheme originally recommended by MDO system 10 (68). In some examples, this benefits report 12 can then be sent over the network 6 to the retail enterprises 4 where the user can further aggregate and analyze the data. In some examples, this benefits report 12 could be stored in the benefit analysis data store 42D for future access by user retail enterprises 4.

FIG. 5 is a flow diagram illustrating, in greater detail, recalibration of the econometric model (step 64 of FIG. 4) in view of the actuals. In the example implementation shown in FIG. 5, recalibration module 34 recalibrates the econometric model by first accessing the data specifying the initial inventory, the prices specified in the markdown schedule and actual volume data as provided by the retail enterprise upon completion of the schedule (76). Based on the initial inventory and actual volume data, recalibration module 24 computes, for each product store, actual inventory for all weeks (or other recurring time period) in the plan (78).

Next, optimization engine 25 applies the remodeled data, i.e., the econometric model that was updated with the actuals, to generate a new forecast (referred to as Forecast A) (80). At this time, econometric engine 25 applies the actual prices utilized by the retail enterprise, as set by the original markdown schedule, for each product-store. In some examples, both the actual price and the actual inventory may need to be entered into an econometric engine, depending on whether the demand forecast relies on inventory or not. In this way, Forecast A provides a forecast for every product by store by week using the pricing scheme originally recommended by MDO system 10.

Recalibration module 34 then identifies, for all products and for each store, all weeks where the actual inventory was not constrained during implementation of the markdown schedule (82). A week is not constrained when the actual inventory is greater than 0 at the end of the week, i.e., at least some excess inventory existed and did not constrain sales at the current price for that week.

For each product/store combination, recalibration module 34 calculates a summation of forecasted unit sales (referred to as “TA”) across of the non-constrained weeks of Forecast A (86). Recalibration module 34 then similarly computes, for each product/store combination, a summation of actual unit sales (referred to as “TAV”) achieved for each week during implementation of the markdown schedule where the actual inventory for that week was not constrained (88).

Based on these two summations, recalibration module 34 calculates, for each store of the retail enterprise, a corresponding store-product level recalibration factor (“recalibration factor”) using the following equation (90):

Recalibration Factor=TAV/TA.

If TA is equal to zero, meaning that a given product-store combination does not have any week with non-inventory-constrained demand (i.e., all weeks were inventory constrained), then the recalibration factor is set equal to 1. In this way, recalibration module 34 computes a set of store-level recalibration factors for application to the model.

As discussed above with respect to FIG. 4, recalibration module 34 applies the recalibration factors to the updated model and generates a forecast (“Forecast B”) for each product-store using the user-defined price scheme (66). Report generation module 32 generates benefits report 12 by calculating and illustrating the differences between application of the recalibrated model to the user-defined pricing strategy (i.e., Forecast B) and the actual data achieved for both sales and inventory level when the retail enterprise implemented the pricing scheme originally recommended by MDO system 10 (68). At this time, report generation module 32 may compare Forecast B to the actuals as a basis for generating the report.

As another example, report generation module 32 may utilize the updated model and recalibration factors to regenerate a forecast for each product-store using the pricing scheme recommended by MDO system 10 and compare this regenerated forecast to the forecast based on the user-defined pricing scheme (Forecast B) (94).

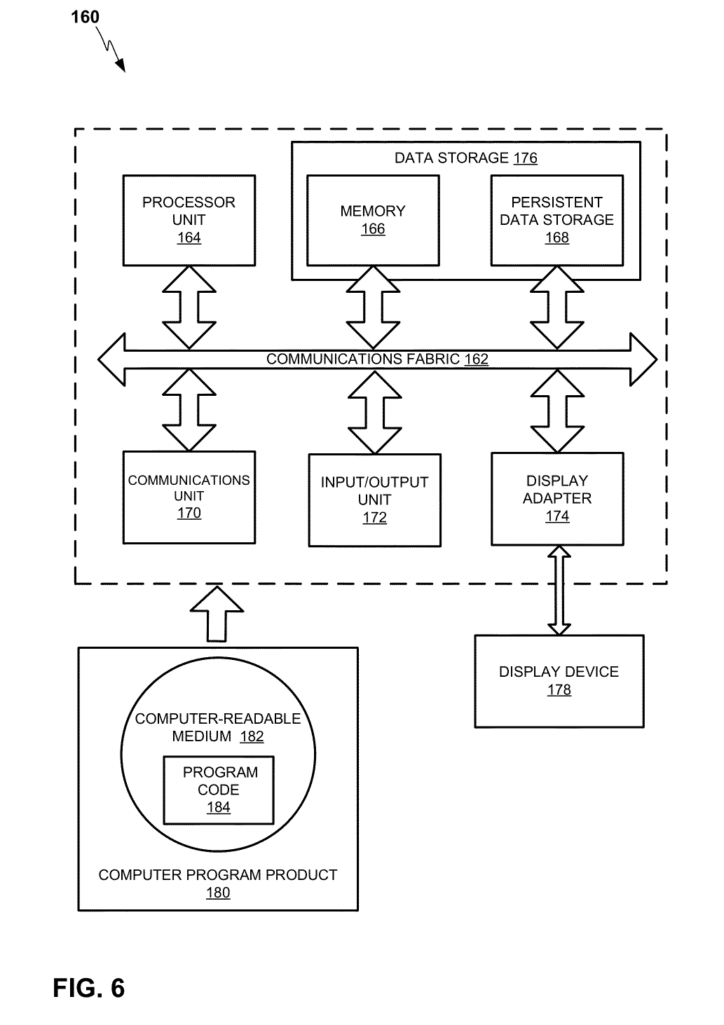

FIG. 6 is a block diagram of an example computing device that may execute markdown optimization (MDO) software with benefits report generation, according to an illustrative example. The MDO software application with benefits report generation may enable creation and operation of benefits reports either by incorporating this capability within a single application, or by making calls or requests to or otherwise interacting with any of a number of other modules, libraries, data access services, indexes, databases, servers, or other computing environment resources, for example. Computing device 160 may be a workstation, server, mainframe computer, notebook or laptop computer, desktop computer, tablet, smartphone, feature phone, or other programmable data processing apparatus of any kind Computing device 160 of FIG. 6 may represent any of application servers 22, IO servers 20, or database servers 24 as depicted in FIG. 2, for example. Other possibilities for computing device 160 are possible, including a computer having capabilities or formats other than or beyond those described herein.

In this illustrative example, computing device 160 includes communications fabric 162, which provides communications between processor unit 164, memory 166, persistent data storage 168, communications unit 170, and input/output (I/O) unit 172. Communications fabric 162 may include a dedicated system bus, a general system bus, multiple buses arranged in hierarchical form, any other type of bus, bus network, switch fabric, or other interconnection technology. Communications fabric 162 supports transfer of data, commands, and other information between various subsystems of computing device 160.

Processor unit 164 may be a programmable central processing unit (CPU) configured for executing programmed instructions stored in memory 166. In another illustrative example, processor unit 164 may be implemented using one or more heterogeneous processor systems in which a main processor is present with secondary processors on a single chip. In yet another illustrative example, processor unit 164 may be a symmetric multi-processor system containing multiple processors of the same type. Processor unit 164 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 164 may include a multi-core processor, such as a dual core or quad core processor, for example. Processor unit 164 may include multiple processing chips on one die, and/or multiple dies on one package or substrate, for example. Processor unit 164 may also include one or more levels of integrated cache memory, for example. In various examples, processor unit 164 may include one or more CPUs distributed across one or more locations.

Data storage 176 includes memory 166 and persistent data storage 168, which are in communication with processor unit 164 through communications fabric 162. Memory 166 can include a random access semiconductor memory (RAM) for storing application data, i.e., computer program data, for processing. While memory 166 is depicted conceptually as a single monolithic entity in FIG. 6, in various examples, memory 166 may be arranged in a hierarchy of caches and in other memory devices, in a single physical location, or distributed across a plurality of physical systems in various forms. While memory 166 is depicted physically separated from processor unit 164 and other elements of computing device 160, memory 166 may refer equivalently to any intermediate or cache memory at any location throughout computing device 160, including cache memory proximate to or integrated with processor unit 164 or individual cores of processor unit 164.

Persistent data storage 168 may include one or more hard disc drives, solid state drives, flash drives, rewritable optical disc drives, magnetic tape drives, or any combination of these or other data storage media. Persistent data storage 168 may store computer-executable instructions or computer-readable program code for an operating system, application files that include program code, data structures or data files, and any other type of data. These computer-executable instructions may be loaded from persistent data storage 168 into memory 166 to be read and executed by processor unit 164 or other processors. Data storage 176 may also include any other hardware elements capable of storing information, such as, for example and without limitation, data, program code in functional form, and/or other suitable information, either on a temporary basis and/or a permanent basis.

Persistent data storage 168 and memory 166 are examples of physical, tangible, non-transitory computer-readable data storage devices. Data storage 176 may include any of various forms of volatile memory that may require being periodically electrically refreshed to maintain data in memory, but those skilled in the art will recognize that this also constitutes an example of a physical, tangible, non-transitory computer-readable data storage device. Executable instructions are stored on a non-transitory medium when program code is loaded, stored, relayed, buffered, or cached on a non-transitory physical medium or device, including if only for only a short duration or only in a volatile memory format.

Processor unit 164 can also be suitably programmed to read, load, and execute computer-executable instructions or computer-readable program code for a BI application with drillable chart matrixes, as described in greater detail above. This program code may be stored on memory 166, persistent data storage 168, or elsewhere in computing device 160. This program code may also take the form of program code 184 stored on computer-readable medium 182 that is included in computer program product 180, and may be transferred or communicated, through any of a variety of local or remote means, from computer program product 180 to computing device 160 to be enabled to be executed by processor unit 164, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, a mobile device operating system such as iOS® from Apple® Inc., or any other suitable operating system. Processor unit 164 can be suitably programmed to read, load, and execute instructions of the operating system.

Communications unit 170, in this example, provides for communications with other computing or communications systems or devices. Communications unit 170 may provide communications through the use of physical and/or wireless communications links. Communications unit 170 may include a network interface card for interfacing with a network 6, an Ethernet adapter, a Token Ring adapter, a modem for connecting to a transmission system such as a telephone line, or any other type of communication interface. Communications unit 170 can be used for operationally connecting many types of peripheral computing devices to computing device 160, such as printers, bus adapters, and other computers. Communications unit 170 may be implemented as an expansion card or be built into a motherboard, for example.

The input/output unit 172 can support devices suited for input and output of data with other devices that may be connected to computing device 160, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 172 may also include any type of interface for video output in any type of video output protocol and any type of monitor or other video display technology, in various examples. It will be understood that some of these examples may overlap with each other, or with example components of communications unit 170 or data storage 176. Input/output unit 172 may also include appropriate device drivers for any type of external device, or such device drivers may reside in the operating system or elsewhere on computing device 160 as appropriate.

Computing device 160 also includes a display adapter 174 in this illustrative example, which provides one or more connections for one or more display devices, such as display device 178, which may include any of a variety of types of display devices, including a display screen for displaying a user interface (e.g., as shown in UI examples 100, 110, 120, 130, 140, and 150 of FIGS. 3A-3F) for a benefits report generating MDO system 10 as shown in FIG. 2. It will be understood that some of these examples may overlap with example components of communications unit 170 or input/output unit 172. Input/output unit 172 may also include appropriate device drivers for any type of external device, or such device drivers may reside in the operating system or elsewhere on computing device 160 as appropriate. Display adapter 174 may include one or more video cards, one or more graphics processing units (GPUs), one or more video-capable connection ports, or any other type of data connector capable of communicating video data, in various examples. Display device 178 may be any kind of video display device, such as a monitor, a television, or a projector, in various examples.

Input/output unit 172 may include a drive, socket, or outlet for receiving computer program product 180, which includes a computer-readable medium 182 having computer program code 184 stored thereon. For example, computer program product 180 may be a CD-ROM, a DVD-ROM, a Blu-Ray disc, a magnetic disc, a USB stick, a flash drive, or an external hard disc drive, as illustrative examples, or any other suitable data storage technology. Computer program code 184 may include a BI application with drillable chart matrixes, as described above.

Computer-readable medium 182 may include any type of optical, magnetic, or other physical medium that physically encodes program code 184 as a binary series of different physical states in each unit of memory that, when read by computing device 160, induces a physical signal that is read by processor 164 that corresponds to the physical states of the basic data storage elements of storage medium 182, and that induces corresponding changes in the physical state of processor unit 164. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 164, thereby physically causing processor unit 164 to generate physical outputs that correspond to the computer-executable instructions, in a way that modifies computing device 160 into a new physical state and causes computing device 160 to physically assume new capabilities that it did not have until its physical state was changed by loading the executable instructions included in program code 184.

In some illustrative examples, program code 184 may be downloaded or otherwise accessed over a network to data storage 176 from another device or computer system, such as a server, for use within computing device 160. Program code 184 that includes computer-executable instructions may be communicated or transferred to computing device 160 from computer-readable medium 182 through a hard-line or wireless communications link to communications unit 170 and/or through a connection to input/output unit 172. Computer-readable medium 182 that includes program code 184 may be located at a separate or remote location from computing device 160, and may be located anywhere, including at any remote geographical location anywhere in the world, and may relay program code 184 to computing device 160 over any type of one or more communication links, such as the Internet and/or other packet data networks. The program code 184 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 184 may be transmitted from a source computer-readable medium 182 over non-tangible media, such as communications links or wireless transmissions containing the program code 184. Program code 184 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 160.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other aspects are within the scope of the following claims.

1-7. (canceled)

8. A markdown optimization system comprising:
one or more processors;
an optimization engine executed by the one or more processors to compute, in accordance with an econometric model, a recommended markdown schedule that specifies pricing reductions for a set of products over a period of time;
a recalibration module executing on the one or more processor that updates the econometric model based on data indicative of actual unit sales of the products that occurred when the products were sold in accordance with the recommended markdown schedule; and
a report generation module executing on the one or more processor that computes, based on the updated econometric model, a profit difference between the sale of the products in accordance with the recommended markdown schedule and sale of the products in accordance with a user-defined markdown schedule.

9. The markdown optimization system of claim 8, wherein the report generation module outputs a profit benefit report indicative of the computed profit difference.

10. The markdown optimization system of claim 8, wherein the report generation module determines the profit difference by processing the updated econometric model in accordance with pricing data specified by the user-defined markdown schedule to compute a forecast for sales of the set of product when sold in accordance the user-defined markdown schedule and comparing the forecast to the actual unit sales of the products when sold in accordance with the markdown schedule.

11. The markdown optimization system of claim 8, further comprising a recalibration module that scales the model based on the actual unit sales of the products when sold in accordance with the recommended markdown schedule.

12. The markdown optimization system of claim 11, the recalibration module scales the econometric model by:
processing the updated econometric model in accordance with pricing data specified by the recommended markdown schedule to compute a forecast for sales of the set of product when sold in accordance the recommended markdown schedule;
computing one or more calibration factors based on a comparison of the forecast to the actual unit sales of the products that occurred when the products were sold in accordance with the recommended markdown schedule; and
scaling the econometric model based on the one or more calibration factors.

13. The markdown optimization system of claim 12,
wherein the recalibration module computes a corresponding calibration factor for each store in which the products were sold in accordance with the recommended markdown schedule, and
wherein the recalibration module scales a coefficient for each of the stores in the econometric model based on the corresponding calibration factor computed for the store.

14. The markdown optimization system of claim 13, wherein the recalibration module computes the corresponding calibration factor for each store by:
identifying, for the period in which the products were sold in accordance with the recommended markup schedule, each week in which the products was sold without being constrained by inventory;
calculating, from the forecast, a summation of forecasted sales for each of the identified weeks;
calculating, from the actual unit sales, a summation of the actual unit sales that occurred for each of the identified weeks; and
computing the calibration factor for the store by dividing the sum of the actual unit sales for the identified weeks by the sum of the forecasted unit sales for the identified weeks.

15. The markdown optimization system of claim 13, wherein the recalibration module computes a recalibration factor for each store specified in the econometric model.

16. A computer-readable storage medium comprising instructions that cause a processor to:
access a recommended markdown schedule, wherein the recommended markdown schedule was generated in accordance with an econometric model and specifies pricing reductions for a set of products over a period of time;
update the econometric model based on data indicative of actual unit sales of the products that occurred when the products were sold in accordance with the recommended markdown schedule;
compute, based on the updated econometric model, a profit difference between the sale of the products in accordance with the recommended markdown schedule and sale of the products in accordance with a user-defined markdown schedule; and
output a profit benefit report indicative of the computed profit difference.

17. The storage medium of claim 16, further comprising instructions that cause the processor to:
process the updated econometric model in accordance with pricing data specified by the user-defined markdown schedule to compute a forecast for sales of the set of product when sold in accordance the user-defined markdown schedule; and
compare the forecast to the actual unit sales of the products when sold in accordance with the markdown schedule to determine the profit difference.

18. The storage medium of claim 16, further comprising instructions that cause the processor to scale the econometric model based on the actual unit sales of the products when sold in accordance with the recommended markdown schedule.

19. The storage medium of claim 18, further comprising instructions that cause the processor to:
process, with the computer, the updated econometric model in accordance with pricing data specified by the recommended markdown schedule to compute a forecast for sales of the set of product when sold in accordance the recommended markdown schedule;
compute one or more calibration factors based on a comparison of the forecast to the actual unit sales of the products that occurred when the products were sold in accordance with the recommended markdown schedule; and
scale the econometric model based on the one or more calibration factors.

20. The storage medium of claim 19, further comprising instructions that cause the processor to:
compute a corresponding calibration factor for each store in which the products were sold in accordance with the recommended markdown schedule; and
scale, within the econometric model, a coefficient for each of the stores in the econometric model based on the corresponding calibration factor computed for the store.
